(19) United States
(12) Patent Application Publication
(10) Pub. No.: US 2010/0019433 A1
(43) Pub. Date: Jan. 28, 2010

(54) Sheet folding device, image forming apparatus, and sheet folding method

(75) Inventor: Noriaki Sekine, Saitama (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/458,631

(22) Filed: Jul. 17, 2009

(30) Foreign Application Priority Data
Jul. 23, 2008 (JP) 2008-190272
Feb. 2, 2009 (JP) 2009-021991

(51) Int. Cl. B41F 13/56; B31F 1/00

(52) U.S. Cl. 270/20.1; 493/416

(57) ABSTRACT

A first folding unit puts a first fold line on a sheet in a direction perpendicular to a conveying direction of the sheet and folds the sheet along the first fold line. A second folding unit puts a second fold line on the sheet in a direction perpendicular to the first fold line. A stamp unit aligns a side of the sheet by a reversing unit and a rotation angle of the sheet by a rotating unit based on reverse information indicating whether the sheet is reversed and a rotation angle of the sheet stored in association with a sheet size and a fold type in a storage unit, and puts a stamp on the sheet.

### CROSS-REFERENCE TO RELATED APPLICATIONS

The present application claims priority to and incorporates by reference the entire contents of Japanese priority document 2008-190272 filed in Japan on Jul. 23, 2008 and Japanese priority document 2009-021991 filed in Japan on Feb. 2, 2009.

### BACKGROUND OF THE INVENTION

1. Field of the Invention

The present invention relates to a technology for folding a sheet of recording medium.

2. Description of the Related Art

In a typical copying machine, printing is performed as follows. A sheet of recording medium is fed from a sheet feeding unit to an image forming unit in which an image is transferred onto the sheet. After the image is fixed onto the sheet, the sheet is output to a sheet catch tray.

Copying machines for wide format sheets, such as a drawing sheet, are generally used to form an image on a large sheet, such as an A0 sheet or an A1 sheet. A date and/or an originator's name is stamped in ink on the sheet on which an image has been formed in some cases.

Ink stamp devices that stamp a data and/or an originator's name in ink on a sheet having been folded by an automatic folding apparatus that is connected to a copying machine have been disclosed.

For example, Japanese Patent Application Laid-open No. 2004-25646 discloses an ink stamp device that rotates itself to so that all the sheets receive ink stamping at a single position and in a single orientation.

However, the approach disclosed in Japanese Patent Application Laid-open No. 2004-25646 is disadvantageous in that the mechanism for rotating the ink stamp device according to a fold type and a sheet size is complicated and expensive.

In some cases, the ink stamp device fails to make ink stamping because, for example, a surface where the sheet is to receive the ink stamping faces away from the ink stamp device. This can occur depending on combination of a sheet conveying direction and a sheet size and a fold type.

Meanwhile, because ink is likely to settle downward by the pull of gravity, it is necessary for a stamping surface of an ink stamp device to face upward. When a sheet is output to a sheet catch tray as it is, i.e., with the stamping surface facing down, sheets are stacked in the sheet catch tray in a descending order of pages, which is undesirable.

When a stamp is arranged inside a machine, mounting or dismounting the stamp to and from a sheet folding device is disadvantageously complicated and difficult. In such a configuration, a mechanism for dismounting a stamp head and separating a head holder and a rotation drive unit is complicated. Accordingly, it is necessary to perform the complicated operations to supply ink or change a date on a stamping surface.

### SUMMARY OF THE INVENTION

It is an object of the present invention to at least partially solve the problems in the conventional technology.

According to one aspect of the present invention, there is provided a sheet folding device that folds a sheet, The sheet folding device includes a first folding unit that puts a first fold line on the sheet in a direction perpendicular to a conveying direction of the sheet and folds the sheet along the first fold line; a second folding unit that puts a second fold line on the sheet in a direction perpendicular to the first fold line; a reversing unit that reverses the sheet; a rotating unit that rotates the sheet by a predetermined degrees; a storage unit that stores therein reverse information indicating whether the sheet is reversed and a rotation angle of the sheet in association with a sheet size and a fold type; and a stamp unit that aligns a side of the sheet by the reversing unit and the rotation angle of the sheet by the rotating unit based on information stored in the storage unit, and puts a stamp on the sheet.

Furthermore, according to another aspect of the present invention, there is provided an image forming apparatus including a sheet folding device that folds a sheet. The sheet folding device includes a first folding unit that puts a first fold line on the sheet in a direction perpendicular to a conveying direction of the sheet and folds the sheet along the first fold line, a second folding unit that puts a second fold line on the sheet in a direction perpendicular to the first fold line, a reversing unit that reverses the sheet, a rotating unit that rotates the sheet by a predetermined degrees, a storage unit that stores therein reverse information indicating whether the sheet is reversed and a rotation angle of the sheet in association with a sheet size and a fold type, and a stamp unit that aligns a side of the sheet by the reversing unit and the rotation angle of the sheet by the rotating unit based on information stored in the storage unit, and puts a stamp on the sheet.

Moreover, according to still another aspect of the present invention, there is provided a method of folding a sheet. The method includes first folding including putting a first fold line on the sheet in a direction perpendicular to a conveying direction of the sheet, and folding the sheet along the first fold line; second folding including putting a second fold line on the sheet in a direction perpendicular to the first fold line; reversing the sheet; rotating the sheet by a predetermined degrees; and stamping including aligning a side of the sheet at the reversing and the rotation angle of the sheet at the rotating based on reverse information indicating whether the sheet is reversed and a rotation angle of the sheet stored in advance in association with a sheet size and a fold type, and putting a stamp on the sheet.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an overall schematic configuration diagram of an image forming system according to an embodiment of the present invention;

FIGS. 2 to 4 are schematic rear views of a sheet folding device of the image forming system shown in FIG. 1;

FIGS. 5 and 6 are schematic cross-sectional views of a stamp unit shown in FIGS. 2 to 4;

FIG. 7 is a schematic plan view of the stamp unit shown in FIGS. 5 and 6 as viewed perpendicularly to that of FIG. 5 or 6;

FIG. 8 is a schematic diagram depicting an overall configuration of a stamp shown in FIGS. 5 to 7;

FIG. 9 is a block diagram of a system configuration of the image forming system shown in FIG. 1;

FIG. 10 is a diagram of correspondence between sheet sizes supported by the sheet folding device and fold patterns applicable to the sheet sizes;

FIG. 11 is an exemplary correspondence table in which sheet sizes and cross fold patterns are associated with data indicative of whether a turning-over operation is to be performed and rotation angles; and

FIG. 12 is a schematic diagram depicted an orientation of a sheet being output.

### DETAILED DESCRIPTION OF THE PREFERRED EMBODIMENTS

Exemplary embodiments of the present invention are described in detail below with reference to the accompanying drawings.

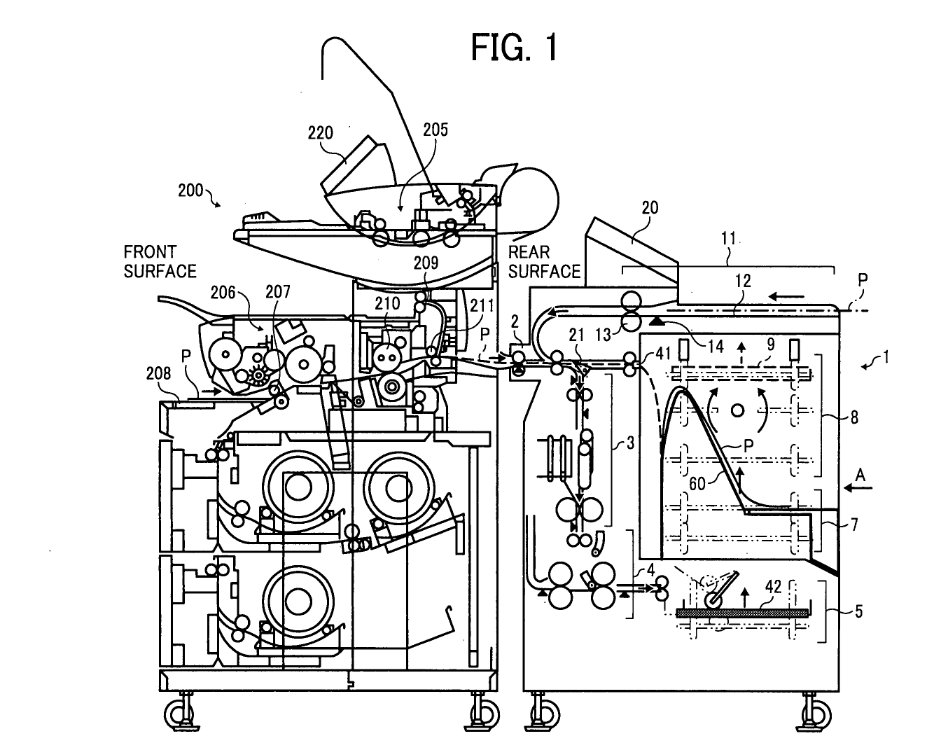

FIG. 1 is an overall schematic configuration diagram of an image forming system according to an embodiment of the present invention.

The image forming system includes a sheet folding device 1 and an image forming apparatus 200. The sheet folding device 1 is connected to a rear surface of the image forming apparatus 200 in which wide format roll of recording medium is housed. When an image is to be formed on a large size sheet, the image forming apparatus 200 cuts the roll according to data indicative of a size of an original and a size of a printout. The image forming apparatus 200 includes an image reading device 205, an image forming unit 206, a pair of registration rollers 207, a manual feed table 208, a pair of sheet delivery rollers 209, a fixing device 210, a pair of sheet output rollers 211, and a first operation input unit 220.

How an image is formed on a sheet of recording medium cut from the roll will be described. Examples of the roll of recording medium include a roll of tracing paper and a roll of transparency. A plurality of rolls can be set in the image forming apparatus 200. Although not shown in FIG. 1, the image forming apparatus 200 includes a sheet pulling unit that pulls the recording medium from the roll, a sheet cutter, and an image transfer unit arranged in this order. The image forming apparatus 200 automatically cuts a sheet from the roll and forms an image on the sheet. The cut size of the sheet is determined based on a detected size of an original and the like.

The image forming apparatus 200 feeds a cut sheet to the image transfer unit, such as a photosensitive drum, where image data read by the image reading device 205 is transferred onto the sheet. The image is fixed onto the sheet by the fixing device 210.

How an image is formed on a manually-fed sheet will be described in detail. The position of the manual feed table 208 is lower than that of the image reading device 205.

A sheet of recording medium placed on the manual feed table 208 is fed to the registration rollers 207. After being temporarily stopped by the registration rollers 207 for timing adjustment, the sheet is fed to the image forming unit 206. In the image forming unit 206, a latent image is formed on a photosensitive element (not shown) based on image data read by the image reading device 205. The latent image is developed with toner to form a toner image that is then fixed onto the sheet by the fixing device 210.

The sheet on which the toner image has been fixed is output to an appropriate one of the sheet folding device 1 and a sheet catch tray of the image forming apparatus 200. More specifically, when the sheet is to be folded, the sheet is output to the sheet folding device 1. In contrast, when the sheet is not to be folded, the sheet is guided upward by a path-switching member (not shown) to the sheet delivery rollers 209 and output to the sheet catch tray.

Concurrent with conveying the sheet to the sheet folding device 1 in this manner, the image forming apparatus 200 transmits data about various items, such as a sheet size, a fold pattern, and parameters related to a fold type, to the sheet folding device 1 via a serial cable.

The sheet folding device 1 receives the data and the sheet from the image forming apparatus 200 and folds the sheet according to the data.

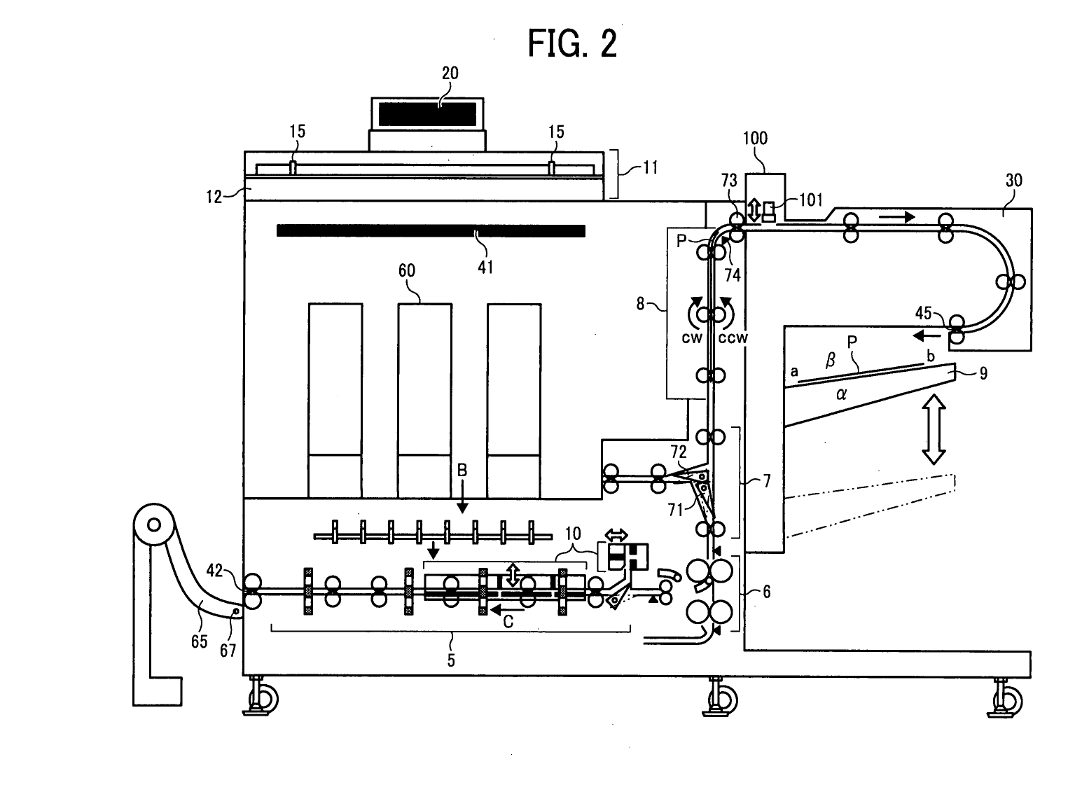

FIG. 2 is a schematic rear view of the sheet folding device 1 taken along an arrow A of FIG. 1. The sheet folding device 1 will be described with reference to FIGS. 1 and 2.

The sheet folding device 1 includes a connecting unit 2, a path switching flap 21, a corner folding unit 3, a fan folding unit 4, a conveying-direction switching unit 5, a cross folding unit 6, a reversing unit 7, a rotating unit 8, and a second operation input unit 20.

The connecting unit 2 is a first sheet inlet port for an online mode. A sheet P of recording medium, onto which an image has been transferred by the image forming apparatus 200, is fed to the sheet folding device 1 by way of the connecting unit 2. A sheet conveying path is switched depending on whether the sheet P is to be folded by using the path switching flap 21.

The corner folding unit 3 folds a corner of the leading end of the sheet P. The fan folding unit 4 folds the sheet P along first folds that extend orthogonal to a direction in which the sheet P is conveyed (hereinafter, “sheet conveying direction”) into a fan-like shape. The sheet conveying direction of the fan-folded sheet is switched by the conveying-direction switching unit 5.

The cross folding unit 6 receives the fan-folded sheet P from the conveying-direction switching unit 5 and folds the fan-folded sheet P along a second fold that extends orthogonal to the first folds into one of regular sizes. The thus-cross-folded sheet P is turned over (upside down) by the reversing unit 7. The sheet P is then rotated by any one of 0 degrees, 90 degrees clockwise (CW), 90 degrees counterclockwise (CCW), and 180 degrees by the rotating unit 8 arranged downstream of the reversing unit 7.

The rotating unit 8 includes a pair of exit rollers 73 that are connected to an electromagnetic clutch (not shown) Transmission of rotational driving force to the exit rollers 73 is switched on and off by the electromagnetic clutch. An exit registration sensor 74 is arranged upstream of the exit rollers 73.

A sheet delivery unit 30 that includes a horizontal conveying path is arranged downstream of a stamp unit 100. The stamp unit 100 is arranged downstream of the rotating unit 8 above the horizontal conveying path. The sheet delivery unit 30 turns the folded sheet P upside down and delivers the sheet P onto a tray 9. Because the stamp unit 100 is arranged above the sheet delivery unit 30, the stamp unit 100 can be incorporated into a conveying unit, which leads to space saving. In this arrangement, because a stamp 101, which will be described later, is directly accessible, components of a mechanism that pulls out the stamp unit 100 are not necessary any more. This leads to reduction in manufacturing cost.

The sheet folding device 1 is arranged such that the reversing unit 7 is downstream of the folding units 3, 4, and 6 and the rotating unit 8 is further downstream of the reversing unit 7. Accordingly, a sheet is protected from being skewed or causing jam in the reversing unit 7 even when the sheet P is then skewed by an angle within an allowable margin of error of the rotation performed by the rotating unit 8.

The sheet folding device 1 also includes a manual feed unit 11. The manual feed unit 11 is a second sheet inlet port for an offline mode. The manual feed unit 11 includes a manual feed table 12. A sheet P of recording medium can be fed to the sheet folding device 1 by placing the sheet P on the manual feed table 12 (offline mode) rather than by way of the image forming apparatus 200.

The sheet folding device 1 also includes a non-folded sheet exit 41 at a position lower than that of the manual feed table 12. A stacker 60, on which no-folded sheets are to be stacked, is arranged at a position lower than that of the non-folded sheet exit 41.

The sheet folding device 1 also includes a first sheet exit 42 on a side opposite from the cross folding unit 6. The first sheet exit 42 is at a position lower than that of the conveying-direction switching unit 5 as shown in FIG. 2. The fan folding unit 4 outputs the fan-folded sheet P through the first sheet exit 42. The sheet conveying direction of the fan-folded sheet P is switched by the conveying-direction switching unit 5.

Inputs for the online mode are entered from the first operation input unit 220 while inputs for the offline mode are entered from the second operation input unit 20. In the online mode, a sheet P of recording medium on which an image has been transferred in the image forming apparatus 200 is fed to the sheet folding device 1 to be folded. In the offline mode, a sheet P of recording medium is directly fed to the sheet folding device 1 from the manual feed unit 11 to be folded without passing through the image forming apparatus 200.

A typical example of the image forming apparatus 200 is an electro-photographic image forming apparatus; however, not limited to an electro-photographic image forming apparatus. The image forming apparatus 200 can be an image forming apparatus of another known type, such as an inkjet type or a thermal transfer type.

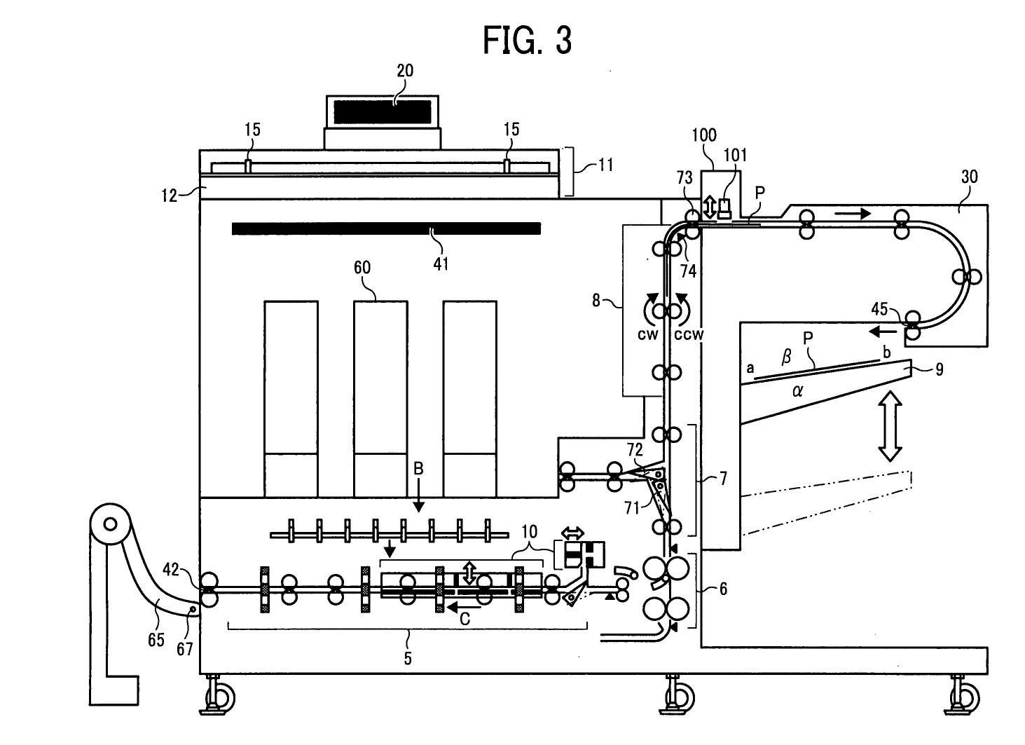

The stamp unit 100 will be described in detail with reference to FIGS. 5 to 9.

FIGS. 5 and 6 are schematic cross-sectional views of the stamp unit 100. FIG. 5 depicts the stamp unit 100 that is ready for ink stamping. FIG. 6 depicts the stamp unit 100 that is performing ink stamping.

The stamp unit 100 includes the stamp 101, a stamp holding member 102, a stamp drive motor 103, a stamp unit casing 107, and an outer cover 106. The stamp holding member 102 holds the stamp 101. The stamp drive motor 103 drives the stamp holding member 102. The stamp unit casing 107 houses the stamp 101, the stamp holding member 102, and the stamp drive motor 103. The stamp holding member 102 includes a rack 102b. The rack 102b meshes with a pinion 105 that is rotatably attached to a drive shaft of the stamp drive motor 103 to transmit drive power of the stamp drive motor 103. The bottom surface of the outer cover 106 serves as an upper sheet-conveying guide 106a.

A plurality of pairs of guide rollers 108 are supported on side plates of the stamp unit casing 107 and vertically arranged. The pairs of the guide rollers 108 guide the stamp holding member 102 in a sliding manner. The stamp holding member 102 is held between each pair of the guide rollers 108, thereby movably guiding the stamp holding member 102. As the stamp drive motor 103 is driven forward or backward, the drive force of the stamp drive motor 103 is transmitted to the rack 102b via the pinion 105, moving the stamp 101 in a corresponding one of vertical directions. The sheet P receives ink stamping from the stamp 101 when the stamp 101 is brought to a lowermost position by the stamp drive motor 103.

The stamp unit casing 107 that includes a stamp-unit casing base 109 and a top panel has a box shape. The stamp unit casing 107 is arranged on a pair of guide members 110 such that the stamp unit casing 107 is slidingly movable on the guide members 110. The guide members 110 extend orthogonal to the sheet conveying direction along the upper sheet-conveying guide 106a. One of the guide members 110 includes a mechanism for causing the stamp unit casing 107 to move along the guide members 110.

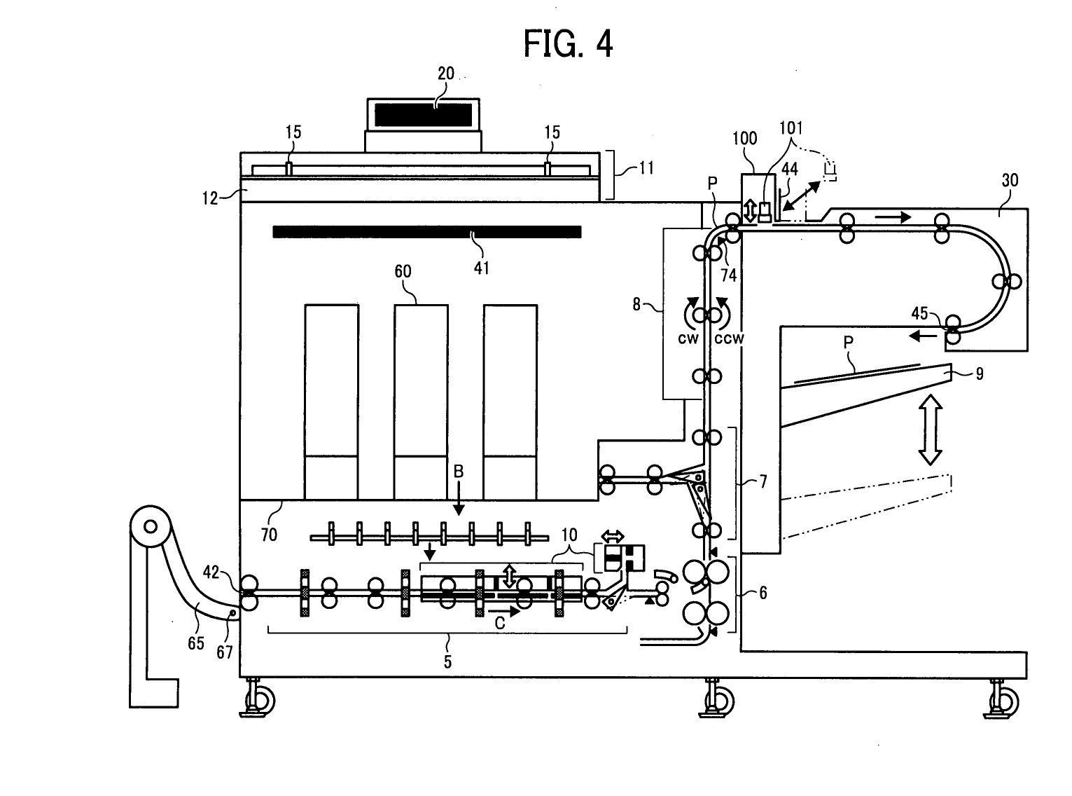

A drive mechanism will be described in detail below. FIG. 7 is a schematic plan view of the stamp unit 100.

The drive mechanism includes a stamp-unit conveying motor 111, a drive pulley 111a, a first driven pulley 110a and a second driven pulley 110b, a first timing belt 112, and a second timing belt 113. The first driven pulley 110a and the second driven pulley 110b are arranged on or near opposite ends of a downstream one of the guide members 110. The first timing belt 112 is wound around the drive pulley 111a and the first driven pulley 110a. The second timing belt 113 is wound around the first driven pulley 110a and the second driven pulley 110b. The second timing belt 113 is connected to the stamp-unit casing base 109 by way of a belt fixing member 114. Because the drive mechanism is constructed in this manner, as the stamp-unit conveying motor 111 is driven forward and backward, the stamp 101 reciprocates orthogonal to the sheet conveying direction. The bottom surface of the outer cover 106 has an opening that serves as a stamp window 115 through which a sheet of recording medium is exposed to the stamp 101. The length of the opening of the stamp window 115 in the sheet conveying direction is set to a moving distance of the stamp unit casing 107.

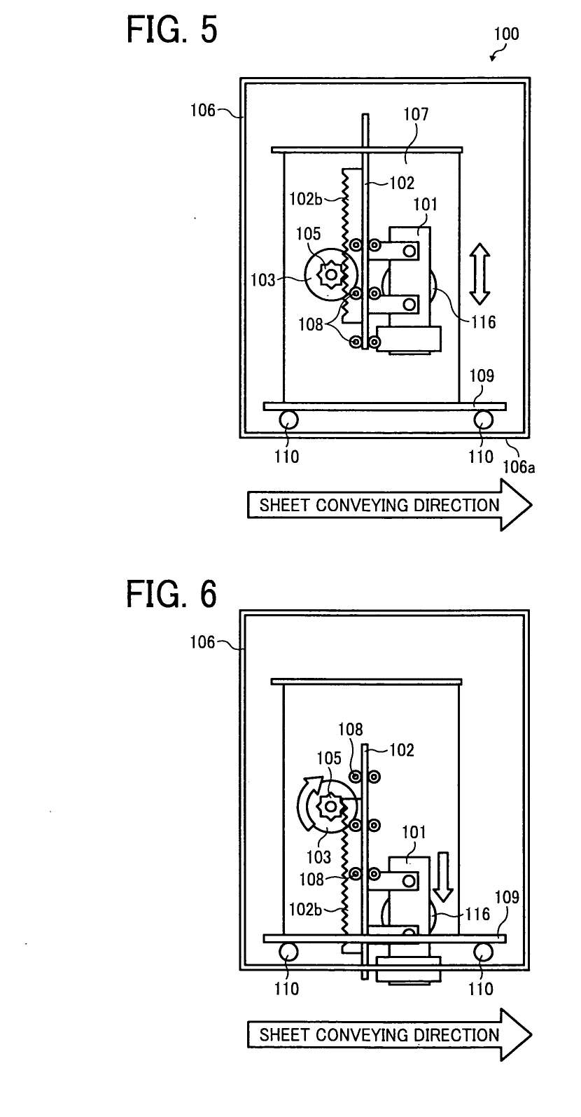

FIG. 8 is a schematic diagram depicting an overall configuration of the stamp 101, which is a date stamp. The year, month, and date on a stamping surface of the stamp 101 can be changed by operating dials 116. In a typical date stamp, characters selectable with the dials 116 are numerical numbers and certain types of symbols; however, the types of the characters selectable by the dials 116 can be changed. By changing the characters, it is possible to increase the number of characters that can be stamped by the stamp 101. For example, the stamp 101 can stamp sequential numbers by using a known mechanism for automatically incrementing a counter.

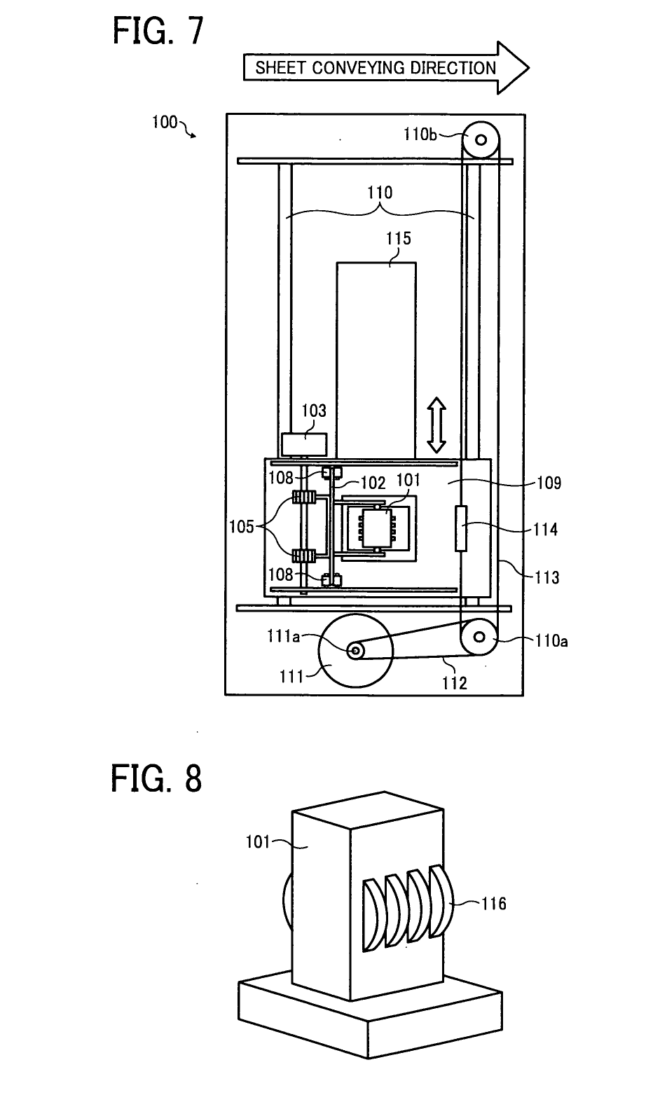

FIG. 9 is a block diagram of a system configuration of the image forming system. The image forming system includes the image forming apparatus 200 and the sheet folding device (post processing apparatus) 1. The image forming apparatus 200 electro-photographically forms an image on a sheet P of recording medium. The sheet folding device 1 receives the sheet P from the image forming apparatus 200 and folds the sheet P.

The image forming apparatus 200 includes a serial-communication unit 331, an operation-input-unit control unit 332, a read control unit 333, a write control unit 334, a sheet conveying unit 335, an image forming unit 336, a fixing control unit 337, a memory control unit 338, and an image-forming-apparatus control unit 340.

The sheet folding device 1 includes an operation-input-unit control unit 311, a fan-fold control unit 312, a cross-fold control unit 313, a conveying-direction-switching control unit 314, a serial-communication unit 315, a corner-fold/punch control unit 316, a rotation/turnover/sheet-exit control unit 317, a sheet-size determining unit 318, a stamp control unit 319, and a sheet folding device control unit 320.

The sheet folding device 1 is connected for communication with the image forming apparatus 200 by way of a serial cable 350. More specifically, the sheet folding device 1 is connected to the serial cable 350 via the serial-communication unit 315 while the image forming apparatus 200 is connected to the serial cable 350 via the serial-communication unit 331, thereby exchanging information with each other.

Examples of information transmitted from the image forming apparatus 200 to the sheet folding device 1 include a sheet size, a fold pattern, whether ink stamping is to be performed, an ink stamping position, a margin size, values for adjusting folding width and length, and whether folding is to be performed. Examples of information transmitted from the sheet folding device 1 to the image forming apparatus 200 include a signal indicative of occurrence of jam in the sheet folding device 1, error-related data, and a fold count.

Operations in the online mode will be described in detail below. In the online mode, a sheet of recording medium, onto which an image has been transferred in the image forming apparatus 200, is fed to the sheet folding device 1 to be folded.

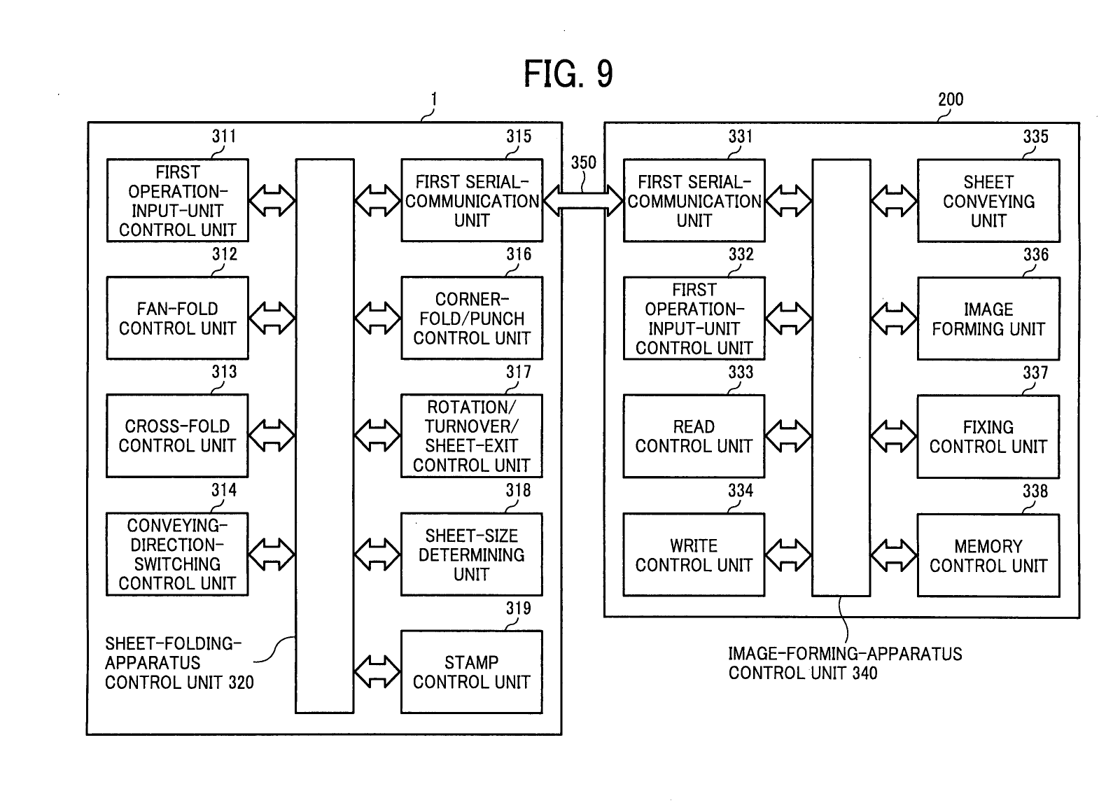

A user selects a size of the sheet P, on which an image is to be formed, on a folding setting screen of the first operation input unit 220. The user also selects one fold type from fold types applicable to the selected sheet size, and the like. Note that the applicable fold type depends on the selected sheet size as shown in FIG. 10.

For example, the supported sheet size are A0 portrait, A1 portrait, A1 landscape, A2 portrait, A2 landscape, A3 portrait, A3 landscape, A4 portrait, and A4 landscape. Any one of the fold types is applicable to a sheet of any one of A0 portrait, A1 portrait, A1 landscape, A2 portrait, A2 landscape, A3 portrait, and A3 landscape. In contrast, a fold type applicable to an A4 sheet or a nonstandard size sheet is limited to one or more specific fold types.

Alternatively, it is possible to fold a sheet automatically in a predetermined fold pattern to save a user from a trouble of determining a fold pattern for each folding operation. This automatic folding can be performed, for example, in a fold pattern having been determined in advance by a combination of the sheet size and the fold pattern.

Fold patterns applicable to a sheet of any one of A0 portrait, A1 portrait, A1 landscape, A2 portrait, A2 landscape, A3 portrait, and A3 landscape are “cross fold”, “cross fold (narrow width)”, and “cross fold (margin)”. In these patterns, a sheet is folded along at least one first fold that extends orthogonal to a sheet conveying direction into a fan-like shape, and thereafter folded along at least one second fold that extends orthogonal to the first fold. These cross fold patterns for a standard size sheet are collectively referred to as “cross fold type”.

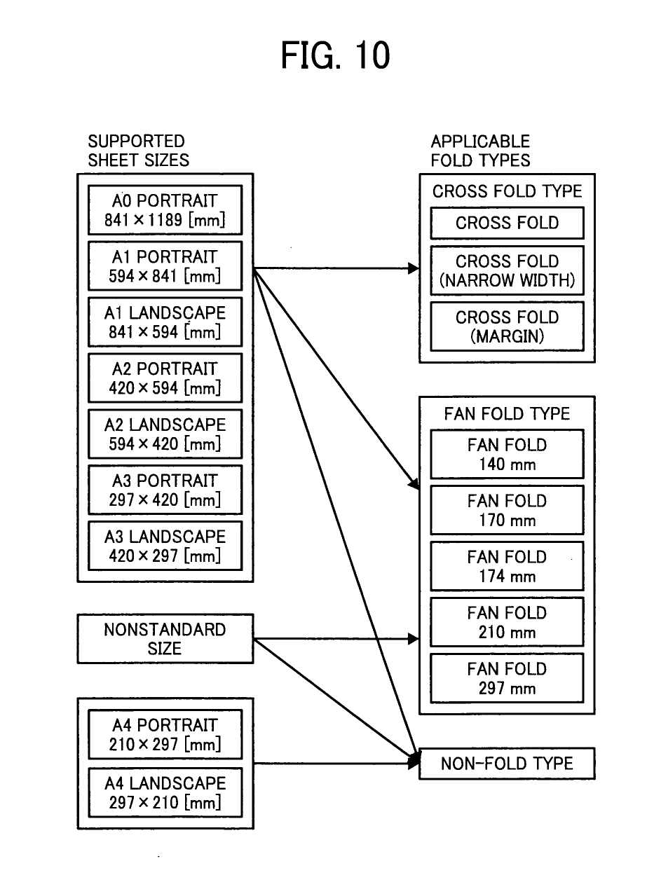

By determining whether to perform a turning-over operation of the sheet and by what rotation angle the sheet is to be rotated for each of combinations of the sheet size and the cross fold pattern in advance, it is possible to output all folded sheets in a single orientation with the surface where the sheet is to receive ink stamping facing the stamp unit 100. FIG. 11 is an exemplary correspondence table in which the sheet sizes and the cross fold patterns are associated with orientation-adjustment information. The orientation-adjustment information include data indicative of whether the turning-over operation is to be performed and rotation angles. The correspondence table is stored in a storage unit (not shown). In this example, the data is stored in the storage unit as the correspondence table; however, the data can be stored in a form other than the correspondence table.

More specifically, while an A0 portrait sheet folded in any one of “cross fold” and “cross fold (narrow width)” is not subjected to the turning-over operation, an A0 portrait sheet folded in “cross fold (margin)” is subjected to the turning-over operation. Because each of an A2 portrait sheet folded in “cross fold”, that in “cross fold (narrow width)”, and that in “cross fold (margin)” is output in the same orientation, the turning-over operation is not performed for all the A2 portrait sheets.

In the correspondence table of FIG. 11, whether a folded sheet is to be turned upside down and rotation angles by which the sheet is to be rotated are associated with the sheet sizes and the fold patterns such that all the sheets are identically orientated by the reversing unit 7 and the rotating unit 8. Meanwhile, the rotating unit 8 rotates the sheet by any one of 0 degrees, 90 degrees CW, 90 degrees CCW, and 180 degrees. Because every sheet is identically oriented with its stamp-receiving surface facing the stamp unit 100 before the sheet is fed to the stamp unit 100, it is possible to perform ink stamping on every folded sheet so long as a sheet size the sheet is supported by the sheet folding device 1 and the fold pattern is applicable to the sheet size.

The sheet folding device 1 can fold a sheet in one fold pattern of the fan fold type other than that of the cross fold type. In a fold pattern of the fan fold type, a sheet is folded into a fan-like shape but not folded along the second fold. Because a sheet is folded only along the first folds, the fold patterns of the fan fold type are applicable to nonstandard size sheets. Examples of the width of the fan-like shape include 140 millimeters, 170 millimeters, 174 millimeters, 210 millimeters, and 297 millimeters. It is also possible to select “non-fold type” other than “cross fold type” and “fan fold type”.

How the sheet folding device 1 operates to fold a sheet in one of the cross fold patterns will be described in detail below. The sheet P, on which an image has been formed by the image forming apparatus 200, is fed to the sheet folding device 1 by the sheet output rollers 211.

The sheet conveying path is switched depending on whether the sheet P is to be folded by using the path switching flap 21. When the sheet P is to be subjected to corner fold, the sheet P is conveyed to the corner folding unit 3. The corner folding unit 3 folds a corner on a leading end of the sheet P while the sheet P is conveyed.

The sheet P out of the corner folding unit 3 is conveyed to the fan folding unit 4 that folds the sheet P along the first folds, and then to the conveying-direction switching unit 5. As shown in FIG. 2, skew correction of the sheet P is performed by the conveying-direction switching unit 5. When the sheet P is to have at least one punch hole, the sheet P is subjected to punching operation. Thereafter, the sheet P is conveyed to the cross folding unit 6 along an arrow C. The sheet P is folded along at least one second fold by the cross folding unit 6 into an A4 size.

Whether the sheet P is to be subjected to the turning-over operation and by what rotation angle the sheet P is to be rotated are determined by referring to the correspondence table stored in the storage unit. When the turning-over operation of the sheet P is to be performed, the sheet P is turned over by the reversing unit 7, and the sheet P is to be rotated by any one of 90 degrees CW, 90 degrees CCW, and 180 degrees, the sheet P is rotated by the rotating unit 8.

The sheet P rotated and output from the rotating unit 8 comes into contact with the exit rollers 73 at the leading end of the sheet P as shown in FIG. 2. Skew correction of the sheet P is performed in this state where the exit rollers 73 are not rotating because of being disengaged from a drive source by the electromagnetic clutch. After a predetermined period of time after the leading end has passed by the exit registration sensor 74, the exit rollers 73 start to rotate, thereby conveying the sheet P to the stamp unit 100 as shown in FIG. 3.

By performing the skew correction immediately before the sheet P receives ink stamping, it is possible to prevent the sheet P from receiving ink stamping in a skewed orientation even when the sheet P has been skewed by an angle within an allowable margin of error of rotation performed by the rotating unit 8.

By performing the skew correction with the leading end of the sheet P abutting the exit rollers 73, it is possible to correct the skew of the sheet P with a simple structure by utilizing already-existing components.

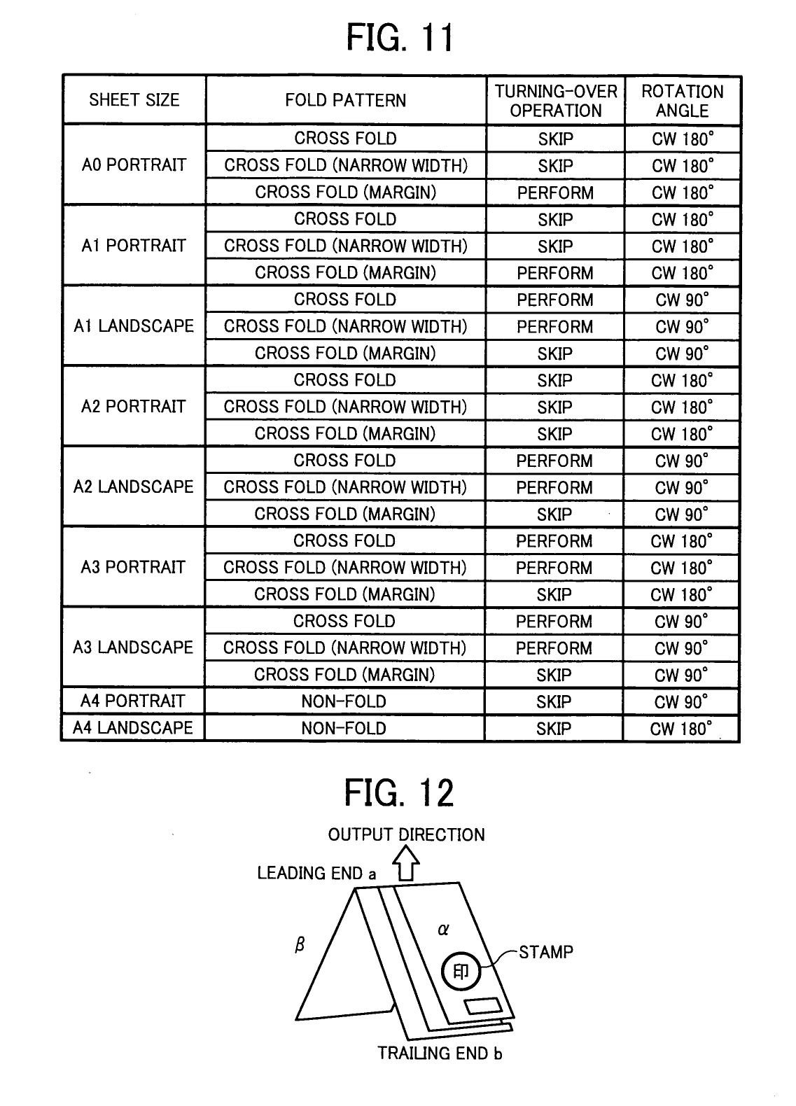

When the sheet P is to receive ink stamping, the sheet P is temporarily stopped at the stamp unit 100 to receive ink stamping on the sheet. The sheet P is then turned upside down in the sheet delivery unit 30. The sheet P is then output to the tray 9 through a second sheet exit 45 in an orientation shown in FIG. 12. More specifically, the sheet P is output to the tray 9 such that a center portion a of the sheet P is at the leading end and a side β, which is the side opposite from a side a where the sheet P has received the ink stamping, faces upward.

According to the present embodiment, every sheet that receives ink stamping is identically oriented with its stamp-receiving surface facing the stamp unit 100 before the sheet receives the ink stamping. Accordingly, because it is not necessary to rotate the stamp unit 100 any more, the structure of the stamp unit 100 is simplified. This permits to manufacture the stamp unit 100 less expensively.

In addition, sheets that have received ink stamping are turned upside down so that the stamped surfaces face downward, and thereafter output to the tray 9. Accordingly, the sheets on the tray 9 are stacked in an increasing order of pages.

How to dismount the stamp 101 from the stamp unit 100 will be described in detail with reference to FIG. 4. When it is necessary to dismount the stamp 101 from the stamp unit 100, a user pulls a stamp door 44 horizontally to an open position indicated by a dotted line in FIG. 4 and takes out the stamp 101 through the stamp door 44. After performing a necessary operation, such as ink supply and/or changing the date on the stamping surface of the stamp 101, the user places the stamp 101 back into the stamp unit 100. By closing the stamp door 44 to a closed position indicated by a solid line in FIG. 4, the stamp unit 100 is brought to a state ready for a next stamping operation.

According to the present embodiment, the stamp 101 is dismounted from the stamp unit 100 through the stamp door 44 that can be pulled horizontally to an open state. The stamp door 44 is arranged on the horizontal conveying path. This arrangement facilitates a user in viewing the stamp 101 while the user dismount the stamp 101 from the stamp unit 100, thereby facilitating mounting and dismounting of the stamp 101.

According to an aspect of the present invention, because a stamp unit has a simple structure, it is possible to manufacture the stamp unit less expensively.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A sheet folding device that folds a sheet, the sheet folding device comprising:
a first folding unit that puts a first fold line on the sheet in a direction perpendicular to a conveying direction of the sheet and folds the sheet along the first fold line;
a second folding unit that puts a second fold line on the sheet in a direction perpendicular to the first fold line;
a reversing unit that reverses the sheet;
a rotating unit that rotates the sheet by a predetermined degrees;
a storage unit that stores therein reverse information indicating whether the sheet is reversed and a rotation angle of the sheet in association with a sheet size and a fold type; and
a stamp unit that aligns a side of the sheet by the reversing unit and the rotation angle of the sheet by the rotating unit based on information stored in the storage unit, and puts a stamp on the sheet.

2. The sheet folding device according to claim 1, further comprising a reverse discharging unit that discharges the sheet by reversing the sheet output from the stamp unit.

3. The sheet folding device according to claim 2, further comprising a receiving unit that is movable up and down and receives the sheet output from the reverse discharging unit at a position lower than the reverse discharging unit.

4. The sheet folding device according to claim 1, wherein the reversing unit and the rotating unit are arranged downstream of the first fold unit and the second fold unit.

5. The sheet folding device according to claim 1, further comprising a skew correcting unit that corrects a skew of the sheet before the stamp unit puts the stamp on the sheet.

6. The sheet folding device according to claim 5, wherein the skew correcting unit corrects the skew of the sheet by abutting a leading edge of the sheet on a discharge roller of either one of the reversing unit and the rotating unit.

7. The sheet folding device according to claim 2, wherein the stamp unit is arranged on a horizontal sheet conveying path of the reverse discharging unit.

8. The sheet folding device according to claim 4, wherein the stamp unit is arranged on a horizontal sheet conveying path of the reverse discharging unit.

9. The sheet folding device according to claim 5, wherein the stamp unit is arranged on a horizontal sheet conveying path of the reverse discharging unit.

10. The sheet folding device according to claim 7, wherein the stamp unit is arranged with a stamping surface facing downward.

11. The sheet folding device according to claim 8, wherein the stamp unit is arranged with a stamping surface facing downward.

12. The sheet folding device according to claim 9, wherein the stamp unit is arranged with a stamping surface facing downward.

13. The sheet folding device according to claim 10, wherein the stamp unit includes a stamp that is taken out from the stamp unit with opening of a cover.

14. The sheet folding device according to claim 11, wherein the stamp unit includes a stamp that is taken out from the stamp unit with opening of a cover.

15. The sheet folding device according to claim 12, wherein the stamp unit includes a stamp that is taken out from the stamp unit with opening of a cover.

16. The sheet folding device according to claim 1, wherein the sheet is folded in a fold pattern determined in advance according to the sheet size.

17. An image forming apparatus comprising a sheet folding device that folds a sheet, the sheet folding device including
a first folding unit that puts a first fold line on the sheet in a direction perpendicular to a conveying direction of the sheet and folds the sheet along the first fold line,
a second folding unit that puts a second fold line on the sheet in a direction perpendicular to the first fold line,
a reversing unit that reverses the sheet,
a rotating unit that rotates the sheet by a predetermined degrees,
a storage unit that stores therein reverse information indicating whether the sheet is reversed and a rotation angle of the sheet in association with a sheet size and a fold type, and
a stamp unit that aligns a side of the sheet by the reversing unit and the rotation angle of the sheet by the rotating unit based on information stored in the storage unit, and puts a stamp on the sheet.

18. A method of folding a sheet, comprising:
first folding including
putting a first fold line on the sheet in a direction perpendicular to a conveying direction of the sheet, and
folding the sheet along the first fold line;
second folding including putting a second fold line on the sheet in a direction perpendicular to the first fold line;
reversing the sheet;
rotating the sheet by a predetermined degrees; and
stamping including
aligning a side of the sheet at the reversing and the rotation angle of the sheet at the rotating based on reverse information indicating whether the sheet is reversed and a rotation angle of the sheet stored in advance in association with a sheet size and a fold type, and
putting a stamp on the sheet.
